(19) United States
(12) Patent Application Publication
(10) Pub. No.: US 2011/0047024 A1
(43) Pub. Date: Feb. 24, 2011

(54) CASH CHANGE MANAGEMENT SYSTEM

(75) Inventor: Edward David Anstee, Victoria (AU)

Correspondence Address: DAVIS WRIGHT TREMAINE, LLP/Seattle, 1201 Third Avenue, Suite 2200, SEATTLE, WA, 98101-3045, US

(73) Assignee: WHOLESALERS PTY LTD, Mount Waverly, Victoria (AU)

(21) Appl. No.: 12/747,864

(22) PCT Filed: Dec. 1, 2008
(86) PCT No.: PCT/AU08/01774

§ 371 Date: Sep. 13, 2010

(30) Foreign Application Priority Data
Dec. 14, 2007 (AU) 2007906789

(51) Int. Cl. G06Q 30/00

(52) U.S. Cl. 705/14.38

(57) ABSTRACT

A system for exchanging cash change, owed by a vendor to a customer as a result of the customer purchasing a good or a service from the vendor, for an alternative offer of a good or a service, said system for performing the steps of generating change data representing a monetary value of the cash change owed to the customer by the vendor; generating offer data representing said alternative offer of said good or service; receiving acceptance data representing confirmation of acceptance of exchange of said cash change for said alternative offer of said good or service; and generating confirmation data representing confirmation of acceptance of exchange of said cash change for said alternative offer of said good or service, wherein said offer data has an offer value corresponding to said change data.

### FIELD OF THE INVENTION

The present invention relates to a system, process and computer program for exchanging cash change, owed by a vendor to a customer as a result of the customer purchasing a good or a service from the vendor, for an alternative offer of a good or a service.

### BACKGROUND OF INVENTION

When a customer pays for shopping in cash, he or she typically receives change consisting of a combination of high and low denominations of notes and coins. Low denomination cash, especially low denomination coins, may be inconvenient and undesirable for consumers, being viewed as less desirable than an equivalent value in high denomination cash and/or electronic cash. For example, low denomination coins are heavy and occupy more wallet space than an equivalent cash amount of higher denomination notes and coins. This may be particularly inconvenient for a customer who engages in small shopping tasks while travelling to/from his or her workplace; place of residence; or vehicle.

Stores sometimes provide a tip jar to relieve shoppers of the burden of carrying around unwanted change. However, the average shopper buying a litre of milk at the local store, for example, may not feel that the burden of carrying around the relevant change is ameliorated by donating the change to the shop attendant as a tip.

Consumers have previously accumulated low denomination cash received as change and delivered it to their local banks for deposit into their bank accounts. However, this process typically involves the step of bagging the coins into predetermined amounts and transporting the weighty coins to the bank. Consumers have, alternatively, accumulated low denomination cash received as change and used an automated coin counting machine to consolidate its value into higher denomination cash; or vouchers, for example. However, it may be generally inconvenient and time-consuming to accumulate change and to later safely transport it to such a machine. This is especially the case where low denomination change is frequently received.

It is generally desirable to overcome or ameliorate one or more of the difficulties of the prior art, or to at least provide a useful alternative.

### SUMMARY OF INVENTION

In accordance with the present invention, there is provided a system for exchanging cash change, owed by a vendor to a customer as a result of the customer purchasing a good or a service from the vendor, for an alternative offer of a good or a service, said system for performing the steps of:
(a) generating change data representing a monetary value of the cash change owed to the customer by the vendor;
(b) generating offer data representing said alternative offer of said good or service;
(c) receiving acceptance data representing confirmation of acceptance of exchange of said cash change for said alternative offer of said good or service; and
(d) generating confirmation data representing confirmation of acceptance of exchange of said cash change for said alternative offer of said good or service,
   wherein said offer data has an offer value corresponding to said change data.

In accordance with another aspect of the present invention, there is provided a process for exchanging cash change, owed by a vendor to a customer as a result of the customer purchasing a good or a service from the vendor, for an alternative offer of a good or a service, including the steps of:
(a) generating change data representing a monetary value of the cash change owed to the customer by the vendor;
(b) generating offer data representing said alternative offer of said good or service;
(c) receiving acceptance data representing confirmation of acceptance of exchange of said cash change for said alternative offer of said good or service; and
(d) generating confirmation data representing confirmation of acceptance of exchange of said cash change for said alternative offer of said good or service,
   wherein said offer data has an offer value corresponding to said change data.

In accordance with another aspect of the present invention, there is provided a computer program for exchanging cash change, owed by a vendor to a customer as a result of the customer purchasing a good or a service from the vendor, for an alternative offer of a good or a service, said program for performing the steps of:
(a) generating change data representing a monetary value of the cash change owed to the customer by the vendor;
(b) generating offer data representing said alternative offer of said good or service;
(c) receiving acceptance data representing confirmation of acceptance of exchange of said cash change for said alternative offer of said good or service; and
(d) generating confirmation data representing confirmation of acceptance of exchange of said cash change for said alternative offer of said good or service,
   wherein said offer data has an offer value corresponding to said change data.

### BRIEF DESCRIPTION OF THE DRAWINGS

Preferred embodiments of the present invention are hereinafter described, by way of example only, with reference to the accompanying drawings, in which:

FIG. 1 is a hardware architecture diagram of a change management system;

FIG. 2 is a flowchart of a process for defining offers performed by the system of FIG. 1;

FIG. 3 is a flowchart of a process for generating an offer for a customer performed by the system of FIG. 1;

FIG. 4 is a flowchart of a voucher redemption process performed by the system of FIG. 1; and

FIG. 5 is a flowchart of a voucher expiration process performed by the system of FIG. 1.

### DETAILED DESCRIPTION OF PREFERRED EMBODIMENTS OF THE INVENTION

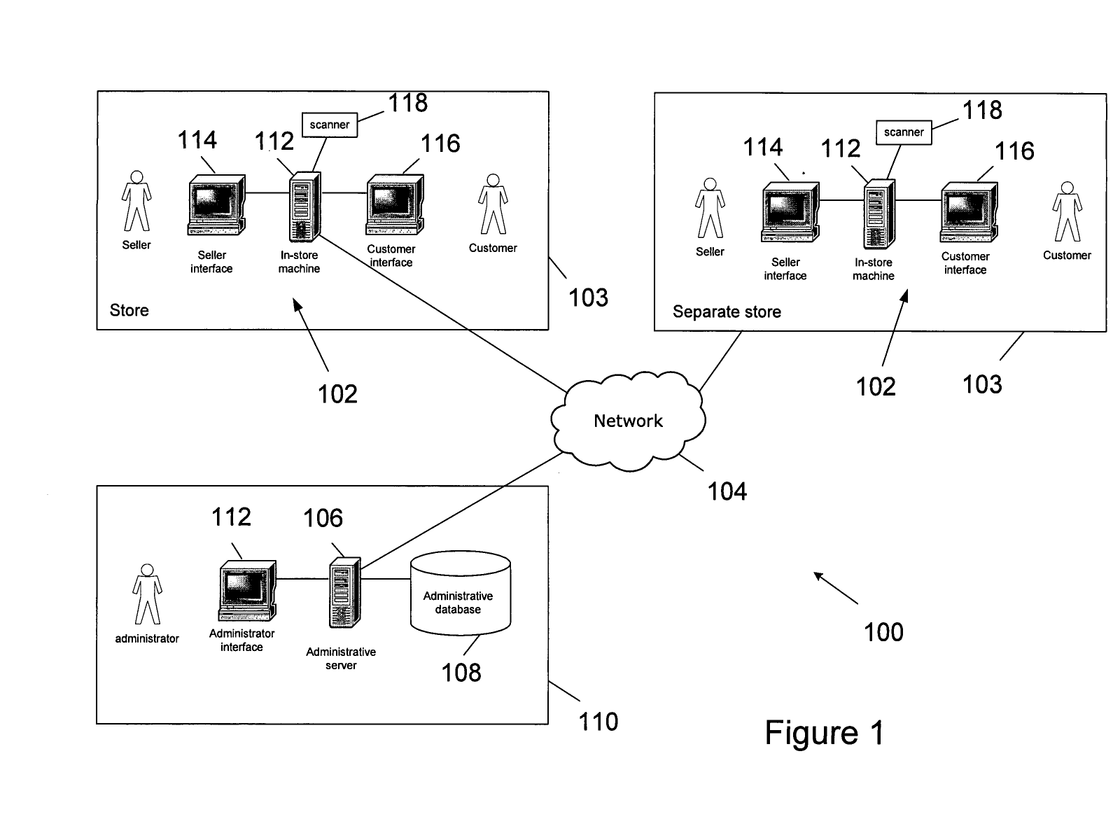

The system 100 for exchanging cash change, owed by a vendor to a customer as a result of the customer purchasing a good or a service from the vendor, for an alternative offer of a good or a service shown in FIG. 1, includes a plurality of store systems 102 in electric communication with an administrator system 110.

Each store system 102 includes an in-store machine 112, e.g. a standard personal computer. The store system 102 also includes a seller interface 114 and a customer interface 116 for communicating with the seller and the customer in the store 102. Store hardware further includes a scanner; a customer display unit; a receipt printer; and a regular printer.

The administrator system 110 includes an administrative server 106 operable by a system administrator via an administrator interface 112. The administrative server 106 stores and distributes data relating to:
1. Available offers;
2. Outstanding offers for redemption;
3. Expired offers; and
4. Rules for defining new offers.

The system 100 is used at the point of sale in a store to generate, for a customer, one or more alternative offers in lieu of cash change. The system 100 allows customers, for whom small change is an inconvenience, to take up an offer that represents something of value to them, such as a voucher for a product, rather than receiving a pocket full of cash change.

The system 100 preferably provides a customer with an offer of value instead of cash change. The offer is selected to provide ongoing, or increased, profitability for a store 103, or chain of stores 103, and to provide a high perceived value for the customer. The perceived value for the customer may be influenced by the absolute amount of the change owed; the coin component of the changed owed (especially for low denomination coins); and the customer's willingness to receive an offer in lieu of the change owed.

The offers made to customers can typically be characterised into three distinct types:
1. Vouchers;
2. Charitable donations; and
3. Deposit to a stored value card.

An offer voucher can be highly flexible. For example, the voucher can be printed as a receipt generated by the store system 102. The value of the voucher (i.e. offer value) and the nature of the voucher (i.e. the offer description) may be selected at the point of sale based on data from an analysis of the items purchased by the customer; and up-to-date data regarding costs of products in the store 102 and from the administrator system 110. For example, if the system detects that the person purchased milk, then the voucher may be for discounted milk on the person's next visit to the store.

A voucher may be redeemable for a free product (e.g. receive a free Slurpee); a discount on a product (e.g. 4 cents off per litre for fuel); or for a discount on purchase of combination products (e.g. a soft drink and pie for $1). Offers in the form of vouchers may be preferable for a store owners as the outstanding liability represented in the voucher can be limited by specifying an expiry date for each offer. For example, the voucher may be void after a certain period of time. A further benefit of using a voucher is that there is less delay than that associated with charging value onto a stored value card, which may include scanning the card, entering identification details, etc.

The offer value, related to the value of the change, may be loaded onto a stored value card, such as a store-specific card that allows expenditure of the stored value only in specific locations. Such a card may have security features including magnetic strips, chips and/or RFID components (e.g. a smart card). Example stored value cards include a VISA prepaid card, a ‘myki’ card (Victorian State Government public transport card), a ‘Black Hawk’ gift card, and a store-specific card issued by the store 102 or chain of stores (e.g. a ‘MyerCard’ issued by Myer, in Australia).

A charitable donation can be made directly in lieu of the cash change due, or at least a portion of the change (e.g. that portion comprising low value coins). This form of charitable donation is less time-consuming and more efficient in terms of time and effort than other charitable regimes (e.g. manually collecting coins, or writing cheques to charities). An offer relating to a charitable donation can be updated at any time by the administrator 110, such that up-to-date charitable donations are available to the customer. For example, a charitable donation may be available as an offer in the minutes or hours following an emergency, rather than days later as traditional methods for collecting donations are organised and distributed.

For example, a customer may purchase $4.35 worth of goods with a $5 note. Instead of receiving 65 cents in cash change, the customer may take up an offer of a voucher for a free drink, which may be redeemed at the same store (or different store) on a subsequent visit. The offer value is determined by the system 100 based on the value of cash change that the customer is owed. For example, if the customer was owed $3.25 in change, a voucher of higher value is generated, than in the case where the customer is owed 65 cents in change. The offer may be based on one or more of the following values:
a. the cost, to the store, of the product (the Cost of Goods Sold or COGS);
b. the normal retail price of the product;
c. the value of change relinquished by the customer;
d. a granter rebate, i.e. a financial subsidy for a certain offer from a third party—e.g. a product manufacturer—rather than the store 102;
e. an offer price, i.e. a price to be paid by the customer in addition to the change relinquished (e.g. paid when redeeming a voucher);
f. the store 102's minimum margin, i.e. the minimum value of the change value over the COGS; or
g. the make-up of the change (i.e. the mix of denominations of currency in the change), or at least a change portion, between high-value and low-value currency; e.g. an offer value may be generated equal to 1.5× the change value of ‘silver’ Australian currency (i.e. 5 c, 10 c, 20 c and 50 c coins), or 2× the change value of ‘gold’ coins (i.e. $1 and $2) because ‘silver’ currency may have a lower perceived value in change.

The perceived value will be impacted by the type of product being offered. The system 100 can optimise the perceived value by generating an offer that is particularly relevant to the customer. That is, the offer may be personalized to the customer based on the customer's profile. Information relating to a customer's profile is provided by an analysis of the products being purchased by the customer in the store 102. For example, if the customer purchases a Slurpee™, then a relevant offer may be for a free Slurpee™ on the customer's subsequent visit. The process performed by the system 100 is referred to as “basket analysis”. That is, analysis of the basket of goods/services purchased by the customer at the point of sale, to generate information on possible offers of interest for a customer. The information on possible offers of interest for a customer may be supplemented by a database of known co-buy information. That is, information relating to which products are commonly purchased in combination by customers. Information on co-buys is collected in the store system 102 and transmitted via a data network (e.g. the Internet) 104 to the administration server 106, which stores a database of co-buy data in an administration database 108. The administration database 108 may be further supplemented by co-buy information from third parties, e.g. survey data or data relating to known shopping behaviours.

The system 100 may increase the speed with which cash transactions can be carried out, as there is, advantageously, less need to distribute cash change owed to customers. There is also no need for the customer to receive and store high value change (e.g. notes), and low value change (e.g. coins). Furthermore, when a substantial portion of cash change is replaced by non-cash offers, the store 103 may reduce its change float, i.e. the store 103 requires less cash change to be available. A reduction in float may have a beneficial effect on cash flow management.

The system 100 is adapted to perform the following process:
1. Generate an offer;
2. Cash exchange offer;
3. Voucher redemption process; and
4. Voucher expiration process.

Each one of these processes is explained in detail below.

### 1. Generate Offer

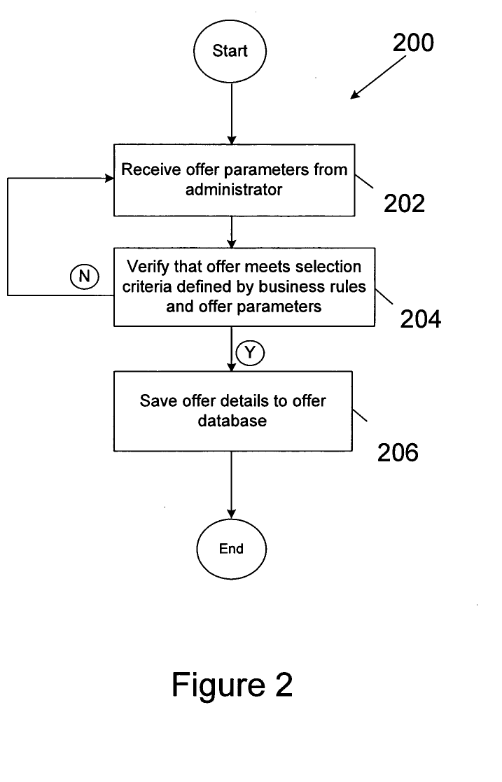

The offers available to customers are generated by the administrator system 110 and stored by the administrative server 106 with the administrative database 108. The steps 200 performed by the system 100 to generate an offer are shown in FIG. 2. The process 200 commences with the administration server 106 receiving, at step 202, offer parameters from the administrator system 110. The offer parameters include an offer description, an offer value, and business rules that determine the offer value based on a change value. For example, a data record representing the offer includes data representing the following information:
a. An Offer Category, i.e. a customer will be presented with only one offer per offer category: (i) Product Offers; (ii) Charity Offers; and (iii) Voucher Offers;
b. An Offer Description; e.g. “leave your change and get a free medium Slurpee on your next visit”;
c. An Offer Period, i.e. the Start Date and End Date of the offer’
d. An Offer Time Period, i.e. the Start Time and End Time of the offer (on each day during the offer period);
e. Days of the Week that the offer will be made to customers;
f. One or more Offer Stores, define by: (i) a wildcard, e.g. “1???” For Victoria, “2???”, for New South Wales, or “4???” for Queensland; (ii) specific Store Numbers; and (iii) Store Numbers in a selected store cluster;
g. One or more Trigger Articles and a Minimum Dollar Sale Amount of the trigger articles (for use in basket analysis processes), defined by: (i) an Article Numbers; and/or (ii) Articles associated with a selected manufacturer;
h. One or more Trigger Categories, and a Minimum Amount of the trigger category articles, associated with one or more Category IDs;
i. An Offer Granter and an associated Value or Level of Subsidy;
j. An Offer Recipient, for charity collection type of offers;
k. A Minimum Change Value required to trigger the offer;
l. A Maximum Change Value to qualify for the offer;
m. One or more Offer Articles, and their respective quantities;
n. An Offer Price;
o. Whether the offer is for immediate redemption only;
p. The Percentage of the Change Value that is shared between the offering and the redeeming stores, i.e. as part of their profits: (i) 10% in most cases; or (ii) 0% in the case of monies to be directly donated; and
q. One or more redemption stores.

The administration server 106 verifies, at step 204, that the values in the offer parameters meet predetermined selection criteria that specify minimum requirements for allowable offers. The verification step 204 checks that all parameters contain relevant data. The verification step 204 also determines whether the offer value lies within an acceptable range in relation to its corresponding change value.

The offer typically includes Sale Conditions, represented on the data record described above, which are defined either as specific articles or as categories, which relate to the goods/services purchased in the customer's basket. For example, the offer may only be available if the customer has purchased goods of at least a certain value (e.g. over $30) or that goods of a certain category have been purchased (e.g. cigarettes, or petrol). The sale conditions impose business rules that analyse data from the basket analysis of a customer's basket, and there from determine whether the offer can be activated for a particular customer/sale (i.e. based on profile data of the customer). The offer may also specify an offer in a particular store 103, for example only stores in certain locations, e.g. in the state of Victoria.

The offer may also define one or more Redeeming Stores, i.e. stores where the offer, at least in the case of a voucher, may be redeemed. For example, a voucher may only be redeemed at the same store 103 in which it issued, or alternatively only in stores owned by a common entity and/or franchise network. An offer may also specify redemption conditions, i.e. the price required to be paid when redeeming a voucher, or the goods for which the voucher is redeemable. This may include an offer price, i.e. the price to be paid in order to redeem the offer. This may be zero, or a small value, e.g. pie and coke for $1.

The offer, in the case of a voucher, may also specify and grant a rebate which is offered by a third party to artificially depress the cost of issuing the voucher for the store 103. For example, a manufacturing or distribution company, e.g. Coca-Cola Amatil, may provide and grant a rebate such that vouchers for a particular product, e.g. Coca-Cola, can be issued for a disproportionately small change amount.

The sale conditions of a voucher offer may allow selection of the offer when the basket analysis process indicates that a customer has purchased a product from a competitor. For example, a voucher for a free product may be provided in a voucher that is selected by the offer selection process when the basket analysis indicates that a competitor's product has been purchased from analysis of the sales data. This mechanism may be particularly useful for new product launches, where an existing product from a competitor is identified in the customer's basket of shopping.

The offer description also includes specification of an offer expiry, which includes the expiration period on a voucher, and the period for which the offer is available to consumers.

If a generated offer does not meet selection criteria in the offer generation process, then corrected offer parameters are received from the administrator (repeat step 202). When the offer meets the selection criteria (step 204), the offer details are saved, at step 206, in the administration database 108 in an offer database.

### 2. Cash Exchange Offer

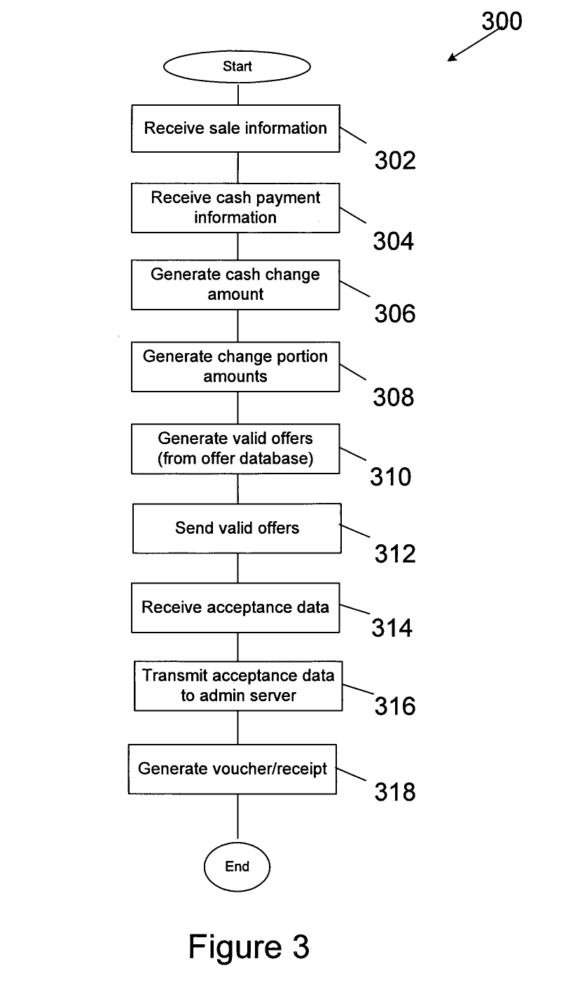

When a customer presents products for purchase in the store 103, the in-store machine 112 performs the cash change offer generation process 300 shown in FIG. 3. The in-store machine 112 receives, at step 302, sale information in the form of sales data from point-of-sale equipment, such as a cash register. The sales information includes data relating to the goods purchased, which may be used for basket analysis to generate profile data of the customer. The in-store machine 112 also receives, at step 304, cash payment information, e.g. from the cash register, or from the seller interface 114 or the customer interface 116, indicating that the customer wishes to pay with cash, and indicating the amount of cash tendered for the payment. From the sales data and the cash payment data, the in-store machine 112 generates, at step 306, a cash change amount, represented in change data, indicating the amount of change due, and the breakdown of this change into the denominations available in the store 102. For example, the change due may include a $5 note, a $2 coin, a 50 cent coin and a 5 cent coin.

In alternative embodiments, the cash change amount data may be received instead of the cash payment data, wherein the change amount in calculated by, for example, a cash register.

Once the cash change amount is generated, at step 306, the in-store machine 112 generates, at step 308, a plurality of change portion amounts, representing a plurality of possible change amounts that represent smaller instances of the change. For example, a change amount of $4.95 may comprise two $2 coins, one 50 cent coin, 2×20 cent coins and one 5 cent coin. The two $2 coins may be of sufficiently high denomination to be desirable to the customer as change, and the smaller instance of change is then 95 cents, comprising the 50 cent, 2×20 cent and the 5 cent coins. Each change amount is broken up into change portion amounts, thus providing a plurality of possible change amounts that may be used to generate a plurality of offers, for the customer, depending on the amount of change that the customer wishes to receive or relinquish.

The in-store machine 112 generates, at step 310, valid offers for the customer based on the change portion amounts, and the available offers from the offer database. Data in the offer database may be accessed directly in the administration database 108, or may be stored by the in-store machine 112 and updated periodically through the connection to the administration server 106. The validity of each available offer is determined in accordance with the selection criteria defined in the parameters of the offer, as generated, at step 310, in the offer definition process of FIG. 3. Valid offers are generated by filtering all current offers in the offer database according to validity criteria, including:
a. Temporal criteria (e.g. today's date is within the offer period; today's day of the week is a valid day of the week for the offer; and the current time is within the Offer Time Period);
b. Outlet or store-based criteria (e.g. the store 102 is a valid Offer Store);
c. Basket-analysis criteria (e.g. that the current sale includes at least a Trigger Article); and
d. Change value criteria (e.g. the amount of change lies between the Minimum Change and Maximum Change amounts).

If a plurality of valid offers is generated, at step 310, in the valid offer generation process, then the in-store machine 112 may select only one of the valid offers, and this selection may be a random selection. Alternatively, a plurality of valid offers may be communicated to the customer, for example one valid offer in each Offer Category (i.e. either a product offer, or a charity offer).

Once valid/relevant offers have been generated, at step 310, the in-store machine 112 sends, at step 312, descriptions of the valid offers to the seller interface 114 and/or the customer interface 116, allowing the customer to select one or more of the valid offers in interactive display, or allowing the seller to describe the offer/s to the customer. For example, the seller may ask the customer whether they wish to receive their change as cash, or as a voucher, or make a charitable donation to a particular charity.

If the customer accepts one of the valid offers from step 312, the seller or the customer indicates this acceptance through the seller interface 114 or the customer interface 116, and the in-store machine 112 receives the acceptance data at step 314. The in-store machine 112 transmits, at step 316, the acceptance data to the administration server 106, where a record is made of the customer's selection, and accounting details are generated for administration of the system 100. The administration server 106 also updates its database of offers, for example to generate a new redeemable voucher record representing a voucher that has been issued, so that the system 100 can account for an outstanding liability generated by issuance of the voucher, and furthermore flag the voucher record with an expiration date.

If a voucher has been selected, the voucher is generated, at step 318, by the in-store machine 112, for example, printed as a written voucher including an identifying barcode or PIN representing unique identification data, using a printer in the store 103, for example included on the shopping receipt. If a charitable donation has been made, a receipt of the donation is generated, at step 318, for the customer. Similarly, if value has been added to a rechargeable value card a receipt is generated, at step 318. If only a portion of the total change owed has been foregone in exchange for the offer (e.g. only silver coins), the in-store machine 112 generates, at step 318, a value of remaining change due to the customer for distribution.

### 3. Voucher Redemption Process

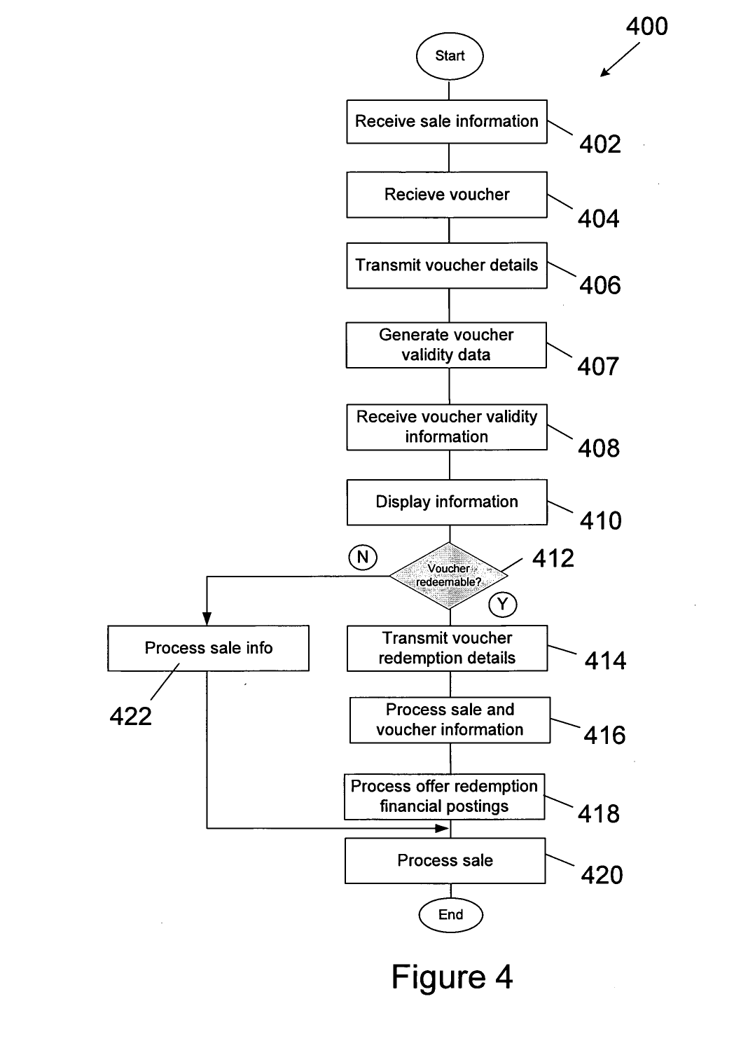

The system 100 performs the steps 400 shown in FIG. 4 to redeem the value of a voucher for a customer. These steps are explained in further detail below.

The customer presents the voucher as part of a point of sale transaction or sale in the store 103. During the transaction, the in-store machine 112 receives, at step 402, sale information including information on the goods and services being sold and their corresponding values. The in-store machine 112 then receives, at step 404, voucher data regarding the voucher presented by the customer. The sale information, and the voucher data, are generated, for example using hardware in the store system 102, including a scanner 118 which optically reads a barcode on the voucher, which provides voucher data, which may be linked to a unique offer record in the offer database (either in the administration database 108, or copied to the in-store machine 112) to provide details of the voucher being redeemed. The in-store machine 112 may therefore transmit, at step 406, the voucher details to the administration server 106 which then generates, at step 407, voucher validity data, including whether or not the voucher has expired, and transmits this back to the in-store machine 112 which receives it in step 408.

Information regarding the status of the offer linked to the voucher is displayed, at step 410, to the seller and/or customer (via the seller interface 114 and/or the customer interface 116) to inform the parties of the offer description. For example, this may indicate that the offer has expired, or that certain products must be purchased in conjunction with the offer.

Whether the voucher is redeemable is determined, at step 412, either automatically by the in-store machine 112 by comparison of the sales data and the voucher offer data (e.g. that the voucher is for a product already included in the basket of goods to be purchased); or through interaction by the seller (e.g. checking that the correct brand of drink has been purchased as specified in the offer). The offer Redemption Conditions also may include type; location; cluster of stores; day of week; and time of day. If the offer is redeemable, then the voucher is considered redeemed and the voucher redemption details are transmitted, at step 414, to the administration server 106 to indicate that the voucher has in fact been redeemed and to update the relevant offer record in the offer database. The in-store machine 112 also generates, at step 416, sales completion data to allow completion of the sale in accordance with the redeemed vouched. For example, this may include reducing the sub-total of the sale in accordance with the value of the voucher corresponding to one or more of the goods in the basket of goods. Financial postings regarding the offer redemption are also generated, at step 418. That is, the redeeming store (which has produced the product) needs to be re-imbursed for the cost of the product less any granter rebates. Any remaining proceeds are shared between the two stores involved. The in-store machine 112 then generates, at step 420, data to allow the seller and buyer to process the sale (e.g. confirmation of the sale is displayed on one of the interfaces). At the end of the voucher redemption process 400, the sale is completed in the store 102. If the sale includes a cash transaction that generates change, the in-store machine 112 will then perform the cash change of a generation process, as shown in FIG. 3.

If the offer is not redeemable, then the voucher is considered void. The in-store machine 112 also generates, at step 422, sales completion data to allow completion of the sale. The in-store machine 112 then generates, at step 420, data to allow the seller and buyer to process the sale (e.g. confirmation of the sale is displayed on one of the interfaces). At the end of the voucher redemption process 400, the sale is completed in the store 102. If the sale includes a cash transaction that generates change, the in-store machine 112 will then perform the cash change of a generation process, as shown in FIG. 3.

### 4. Voucher Expiration Process

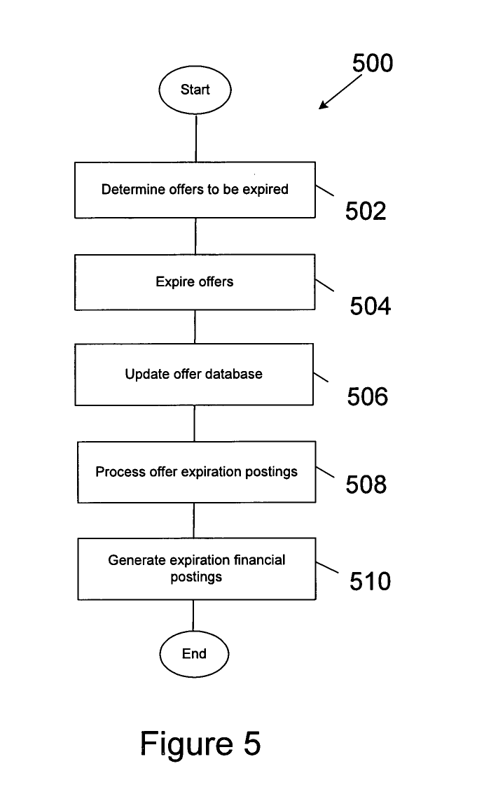

The administration server 106 periodically performs the voucher expiration process 500 shown in FIG. 5 to maintain updated data on current offers in the offer database. The voucher expiration process 500 is performed, for example, on a daily basis. The process 500 commences with the administration server 106 determining, at step 502, which offers are due to expire, by interrogating data in the offer database and the administration database 108. If any offers are due to be expired, then they are marked accordingly, at step 504, and the offer database is then updated, at step 506. Any copies of the offer database, for example the in-store machine 112, are also updated, such that each store accesses up-to-date data on the currency of any offers. Any change left at the Offering Store 102 is recognised as ‘other income’ once an offer has been expired. Offer expiration postings are processed, at step 508. The remaining changed can be passed from liability to revenue to the offering store. Expiration financial postings are also generated, at step 510.

Many modifications will be apparent to those skilled in the art without departing from the scope of the present invention as hereinbefore described with reference to the accompanying drawings.

1. A system for exchanging cash change, owed by a vendor to a customer as a result of the customer purchasing a good or a service from the vendor, for an alternative offer of a good or a service, said system for performing the steps of:
(a) generating change data representing a monetary value of the cash change owed to the customer by the vendor;
(b) generating offer data representing said alternative offer of said good or service;
(c) receiving acceptance data representing confirmation of acceptance of exchange of said cash change for said alternative offer of said good or service; and
(d) generating confirmation data representing confirmation of acceptance of exchange of said cash change for said alternative offer of said good or service,
wherein said offer data has an offer value corresponding to said change data.

2. The system claimed in claim 1, wherein the step of generating offer data includes the step of selecting an offer from a plurality of offers of goods and services based on comparison of said change data and offer values of said plurality of offers of goods and services.

3. The system claimed in claim 1, wherein the step of generating offer data includes the step of selecting an offer from a plurality of offers of goods and services based on the good or the service purchased from the vendor by the customer.

4. The system claimed in claim 1, wherein the step of generating offer data includes the step of selecting an offer from a plurality of offers of goods and services based on profile data associated with the good or the service purchased by the customer.

5. The system claimed in claim 4, wherein the profile data includes known co-buy patterns.

6. The system claimed in claim 4, wherein the profile data includes a good or service in competition with the good or service purchased by the customer.

7. The system claimed in claim 1, wherein said alternative offer of a good or a service is a voucher for a good or a service, said voucher having an offer value that corresponds to the change data.

8. The system claimed in claim 7, wherein the step of generating confirmation data representing confirmation of acceptance of exchange of said cash change for said alternative offer of said good or service includes the step of storing the confirmation data in a computer readable database.

9. The system claimed in claim 7, wherein the step of generating confirmation data representing confirmation of acceptance of exchange of said cash change for said alternative offer of said good or service includes the step of printing a voucher for the customer.

10. The system claimed in claim 7, said system for performing the steps of:
(e) receiving sales data representing information associated with a further good or service being purchased by said customer;
(f) receiving voucher data representing said voucher received by the customer; and
(g) generating sale price data based on a sale price of the further good or service and said voucher data.

11. The system claimed in claim 10, wherein the step of generating sale price data includes the step of deducting any discount associated with the voucher data from a sale price of the further good or service.

12. The system claimed in claim 11, wherein the step of generating sale price data includes the step of checking the validity of the voucher.

13. The system claimed in claim 1, wherein said alternative offer of a good or a service is a donation to a predetermined charity.

14. The system claimed in claim 13, wherein the step of generating confirmation data representing confirmation of acceptance of exchange of said cash change for said alternative offer of said good or service, includes the step of generating data representing the amount of money to be donated to the charity.

15. The system claimed in claim 13, wherein the step of generating confirmation data representing confirmation of acceptance of exchange of said cash change for said alternative offer of said good or service, includes the step of printing a receipt for the customer that includes the donation data.

16. The system claimed in claim 1, wherein said alternative offer of a good or a service is an offer to credit a store value card by said offer value.

17. The system claimed in claim 16, wherein the step of generating confirmation data representing confirmation of acceptance of exchange of said cash change for said alternative offer of said good or service, includes the step of generating data representing the amount of money to be credited on to the store value card in accordance with the corresponding offer value.

18. The system claimed in claim 17, wherein the step of generating confirmation data representing confirmation of acceptance of exchange of said cash change for said alternative offer of said good or service, includes the step of printing a receipt for the customer that includes the said data representing the amount of money credited on to the store value card.

19. The system claimed in claim 1, including an interface for displaying said alternative offer to the customer.

20. The system claimed in claim 1, wherein the cash change relates to a coin component of the cash change.

21. The system claimed in claim 20, wherein the coin component relates to low denomination coins of the cash change.

22. The system claimed in claim 1, wherein the step of generating the offer data is based on selection criteria for selection of the alternative offer.

23. The system claimed in claim 22, wherein the offer selection criteria includes a maximum change value and a minimum change value.

24. The system claimed in claim 1, wherein said alternative offer is made by said vendor and said step of receiving voucher data representing said voucher received by the customer is effected by another vendor.

25. A process for exchanging cash change, owed by a vendor to a customer as a result of the customer purchasing a good or a service from the vendor, for an alternative offer of a good or a service, including the steps of:
(a) generating change data representing a monetary value of the cash change owed to the customer by the vendor;
(b) generating offer data representing said alternative offer of said good or service;
(c) receiving acceptance data representing confirmation of acceptance of exchange of said cash change for said alternative offer of said good or service; and
(d) generating confirmation data representing confirmation of acceptance of exchange of said cash change for said alternative offer of said good or service,
wherein said offer data has an offer value corresponding to said change data.

26. The process claimed in claim 25, wherein the step of generating offer data includes the step of selecting an offer from a plurality of offers of goods and services based on comparison of said change data and offer values of said plurality of offers of goods and services.

27. The process claimed in claim 25, wherein the step of generating offer data includes the step of selecting an offer from a plurality of offers of goods and services based on the good or the service purchased from the vendor by the customer.

28. The process claimed in claim 25, wherein the step of generating offer data includes the step of selecting an offer from a plurality of offers of goods and services based on profile data associated with the good or the service purchased by the customer.

29. The process claimed in claim 28, wherein the profile data includes known co-buy patterns.

30. The process claimed in claim 28, wherein the profile data includes a good or service in competition with the good or service purchased by the customer.

31. The process claimed in claim 25, wherein said alternative offer of a good or a service is a voucher for a good or a service, said voucher having an offer value that corresponds to the change data.

32. The process claimed in claim 31, wherein the step of generating confirmation data representing confirmation of acceptance of exchange of said cash change for said alternative offer of said good or service includes the step of storing the confirmation data in a computer readable database.

33. The process claimed in claim 31, wherein the step of generating confirmation data representing confirmation of acceptance of exchange of said cash change for said alternative offer of said good or service includes the step of printing a voucher for the customer.

34. The process claimed in claim 31, further including the steps of:
(e) receiving sales data representing information associated with a further good or service being purchased by said customer;
(f) receiving voucher data representing said voucher received by the customer; and
(g) generating sale price data based on a sale price of the further good or service and said voucher data.

35. The process claimed in claim 34, wherein the step of generating sale price data includes the step of deducting any discount associated with the voucher data from a sale price of the further good or service.

36. The process claimed in claim 34, wherein the step of generating sale price data includes the step of checking the validity of the voucher.

37. The process claimed in claim 25, wherein said alternative offer of a good or a service is a donation to a predetermined charity.

38. The process claimed in claim 37, wherein the step of generating confirmation data representing confirmation of acceptance of exchange of said cash change for said alternative offer of said good or service, includes the step of generating data representing the amount of money to be donated to the charity.

39. The process claimed in claim 37, wherein the step of generating confirmation data representing confirmation of acceptance of exchange of said cash change for said alternative offer of said good or service, includes the step of printing a receipt for the customer that includes the donation data.

40. The process claimed in claim 25, wherein said alternative offer of a good or a service is an offer to credit a store value card by said offer value.

41. The process claimed in claim 40, wherein the step of generating confirmation data representing confirmation of acceptance of exchange of said cash change for said alternative offer of said good or service, includes the step of generating data representing the amount of money to be credited on to the store value card in accordance with the corresponding offer value.

42. The process claimed in claim 41, wherein the step of generating confirmation data representing confirmation of acceptance of exchange of said cash change for said alternative offer of said good or service, includes the step of printing a receipt for the customer that includes the said data representing the amount of money credited on to the store value card.

43. The process claimed in claim 25, including an interface for displaying said alternative offer to the customer.

44. The process claimed in claim 25, wherein the cash change relates to a coin component of the cash change.

45. The process claimed in claim 44, wherein the coin component relates to low denomination coins of the cash change.

46. The process claimed in claim 25, wherein the step of generating the offer data is based on selection criteria for selection of the alternative offer.

47. The process claimed in claim 46, wherein the offer selection criteria includes a maximum change value and a minimum change value.

48. The process claimed in claim 25, 47, wherein said alternative offer is made by said vendor and said step of receiving voucher data representing said voucher received by the customer is effected by another vendor.

49. A computer program for exchanging cash change, owed by a vendor to a customer as a result of the customer purchasing a good or a service from the vendor, for an alternative offer of a good or a service, said program for performing the steps of:
(a) generating change data representing a monetary value of the cash change owed to the customer by the vendor;
(b) generating offer data representing said alternative offer of said good or service;
(c) receiving acceptance data representing confirmation of acceptance of exchange of said cash change for said alternative offer of said good or service; and
(d) generating confirmation data representing confirmation of acceptance of exchange of said cash change for said alternative offer of said good or service,
wherein said offer data has an offer value corresponding to said change data.

50. The program claimed in claim 49, wherein the step of generating offer data includes the step of selecting an offer from a plurality of offers of goods and services based on comparison of said change data and offer values of said plurality of offers of goods and services.

51. The program claimed in claim 49, wherein the step of generating offer data includes the step of selecting an offer from a plurality of offers of goods and services based on the good or the service purchased from the vendor by the customer.

52. The program claimed in claim 49, wherein the step of generating offer data includes the step of selecting an offer from a plurality of offers of goods and services based on profile data associated with the good or the service purchased by the customer.

53. The program claimed in claim 52, wherein the profile data includes known co-buy patterns.

54. The program claimed in claim 52, wherein the profile data includes a good or service in competition with the good or service purchased by the customer.

55. The program claimed in claim 49, wherein said alternative offer of a good or a service is a voucher for a good or a service, said voucher having an offer value that corresponds to the change data.

56. The program claimed in claim 55, wherein the step of generating confirmation data representing confirmation of acceptance of exchange of said cash change for said alternative offer of said good or service includes the step of storing the confirmation data in a computer readable database.

57. The program claimed in claim 55, wherein the step of generating confirmation data representing confirmation of acceptance of exchange of said cash change for said alternative offer of said good or service includes the step of printing a voucher for the customer.

58. The program claimed in claim 55, said program for further including performing the steps of:
(e) receiving sales data representing information associated with a further good or service being purchased by said customer;
(f) receiving voucher data representing said voucher received by the customer; and
(g) generating sale price data based on a sale price of the further good or service and said voucher data.

59. The program claimed in claim 58, wherein the step of generating sale price data includes the step of deducting any discount associated with the voucher data from a sale price of the further good or service.

60. The program claimed in claim 59, wherein the step of generating sale price data includes the step of checking the validity of the voucher.

61. The program claimed in claim 49, wherein said alternative offer of a good or a service is a donation to a predetermined charity.

62. The program claimed in claim 61, wherein the step of generating confirmation data representing confirmation of acceptance of exchange of said cash change for said alternative offer of said good or service, includes the step of generating data representing the amount of money to be donated to the charity.

63. The program claimed in claim 61, wherein the step of generating confirmation data representing confirmation of acceptance of exchange of said cash change for said alternative offer of said good or service, includes the step of printing a receipt for the customer that includes the donation data.

64. The program claimed in claim 49, wherein said alternative offer of a good or a service is an offer to credit a store value card by said offer value.

65. The program claimed in claim 64, wherein the step of generating confirmation data representing confirmation of acceptance of exchange of said cash change for said alternative offer of said good or service, includes the step of generating data representing the amount of money to be credited on to the store value card in accordance with the corresponding offer value.

66. The program claimed in claim 65, wherein the step of generating confirmation data representing confirmation of acceptance of exchange of said cash change for said alternative offer of said good or service, includes the step of printing a receipt for the customer that includes the said data representing the amount of money credited on to the store value card.

67. The program claimed in claim 49, including an interface for displaying said alternative offer to the customer.

68. The program claimed in claim 49, wherein the cash change relates to a coin component of the cash change.

69. The program claimed in claim 68, wherein the coin component relates to low denomination coins of the cash change.

70. The program claimed in claim 49, wherein the step of generating the offer data is based on selection criteria for selection of the alternative offer.

71. The program claimed in claim 70, wherein the offer selection criteria includes a maximum change value and a minimum change value.

72. The program claimed in claim 49, wherein said alternative offer is made by said vendor and said step of receiving voucher data representing said voucher received by the customer is effected by another vendor.

73. A computer readable data storage medium, including the computer program claimed in claim 49 stored thereon.

74. (canceled)

75. (canceled)

76. (canceled)
